(19) United States
(12) Patent Application Publication
(10) Pub. No.: US 2014/0208961 A1
(43) Pub. Date: Jul. 31, 2014

(54) Grilling Apparatus

(71) Applicant: INNOVATIVE INTERNATIONAL LLC, Lutz, FL (US)

(72) Inventor: Enoch Poon, Tampa, FL (US)

(73) Assignee: INNOVATIVE INTERNATIONAL LLC, Lutz, FL (US)

(21) Appl. No.: 13/752,820

(22) Filed: Jan. 29, 2013

(51) Int. Cl. A47J 37/06

(52) U.S. Cl. CPC A47J 37/06
USPC 99/445; 99/446

(57) ABSTRACT

Disclosed is a grilling apparatus. The grilling apparatus is particularly configured to allow foods to be cooked over an open flame while minimizing flames and smoke. The flams and smoke are sufficiently reduced to permit the grill to be used indoors. The apparatus employs a grill and an underlying collection plate that cooperate in a manner that limits cooking fluids such as grease from dripping onto the open flame. It also suppresses flames generated by the fuel source. In one particular embodiment, the grill and collection plate are positioned over a stove.

### TECHNICAL FIELD

This disclosure relates to a grilling apparatus. More specifically, this disclosure relates to a grilling apparatus that allows food to be cooked over an open flame while minimizing smoke and suppressing flames.

### BACKGROUND OF THE INVENTION

Barbeque grilling is a popular cooking method around the world. Barbeque grilling involves the direct heating of food from an underlying heat source, such as an open flame. The cooking surface is usually a metal grate or grill. The two most widely used grills are charcoal-fueled and gas-fueled. Conventional grilling tends to produce large amounts of smoke as grease and other cooking fluids come into contact with the heat source. These cooking fluids can also cause the flames to flare up and extend above the cooking surface. Various efforts have been made over the years to reduce the smoke and lessen flare ups associated with grilling.

For example, U.S. Pat. No. 6,701,829 to Farrow discloses a rapid anti-flare-up smoker for grills. The cooking device has two plates with apertures. The plates are adapted to be placed together with a gap formed therebetween. Wood chips can be placed in the smoker and the smoker can be placed directly upon a grill. The device allows fire to rise up to the cooking surface and also to catch grease dripping from the meat.

U.S. Pat. No. 6,520,174 to Scigliuolo discloses a two stage fire control cooking apparatus. The apparatus includes a collection plate and a cooking plate. The collection plate has a curved lip that deflects gases being released by the heat source back to the heat source to prevent flames.

Another example is illustrated in U.S. Pat. No. 6,622,616 to Measom. Measom discloses a poultry roaster for use on top of a gas-fired cooker. A heat deflector is included that employs a circular plate for supporting a basting adapter. Holes in the bottom of the device are upwardly punched to form respective upwardly tapered annular grease dams around lower heat distribution holes to prevent grease from falling into the fire.

U.S. Pat. No. 5,735,260 to Rimback discloses a tile for use with a cooking grill. A plurality of frustro-conical bosses extend upwardly from the top surface. Each boss has a channel extending substantially vertically through the tile to the bottom surface. The channels and bosses are shaped to allow drippings to flow through the tile such that a portion of the drippings are vaporized.

Finally, U.S. Pat. No. 4,037,580 to Angelo discloses a meat cooking apparatus. The apparatus includes a container with a closable lid and a fire grate in the bottom. A circular baffle plate is included. The baffle plate includes holes to allow smoke rising from the meat to impinge directly on the meat.

Although each of the foregoing inventions achieves its own individual objective, all suffer from common drawbacks. For example, none of the background art discloses a device that controls the smoke and flames to such an extent that the grilling can be done indoors. The cooking apparatus of the present disclosure is aimed at fulfilling these and other objectives.

### SUMMARY OF THE INVENTION

One possible advantage of the present disclosure is achieved by providing a grilling apparatus that controls smoke and flames to an extent that the apparatus can be used indoors.

A further benefit is realized by providing a grilling apparatus with an apertured collection plate wherein the apertures can be obstructed to in order to control the smoke and flames created while cooking.

Still yet another advantage is attained by providing a grilling apparatus that includes a grill and a collection plate that cooperate in such a manner as to greatly reduce the volume of fluids that come into contact with the heat source or flame.

The present disclosure realizes yet another advantage by including nodules on the lower surface of a cooking surface that cooperate with corresponding apertures within a collection plate, whereby the flames coming into contact with the food can be controlled.

A further possible advantage is the achieved by providing a grilling apparatus wherein the distance between nodules on a cooking surface and associated openings in a collection plate can be varied to control the degree of smoke reduction and flame suppression.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a partially exploded view of the collection plate and grill surface of the present disclosure.

FIG. 2 is a perspective view of the grilling apparatus with the grill inserted over the collection plate.

FIG. 3 is a top plan view of the collection plate of the present disclosure as taken from line 3-3 of FIG. 4.

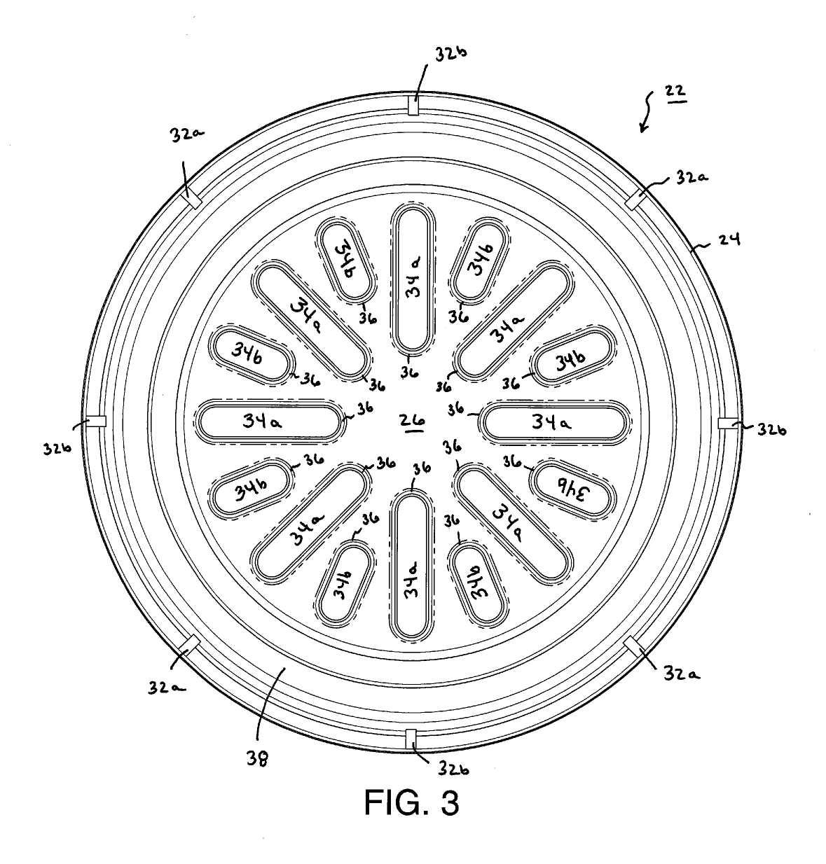

FIG. 4 is a cross sectional view of the collection plate and grill positioned over a stove.

PARTS LIST

| | |
|---|---|
| 10 | Grilling Apparatus |
| 12 | Stove |
| 14 | Bottom Surface of Stove |
| 16 | Upper Peripheral Edge |
| | of Stove |
| 18 | Fuel Source |
| 22 | Collection Plate |
| 24 | Flanged Peripheral |
| | Edge of Collection Plate |
| 26 | Arcuate Bottom Surface |
| | of Collection Plate |
| 28 | Space Between Stove |
| | and Collection Plate |
| 32a | First Notches in |
| | Collection Plate |
| 32b | Second Notches in |
| | Collection Plate |
| 34a | Large Slots in Bottom |
| | of Collection Plate |
| 34b | Small Slots in Bottom |
| | of Collection Plate |
| 36 | Raised Peripheral Edge |
| | of Slot |
| 38 | Trough in Bottom of |
| | Collection Plate |
| 42 | Grill |
| 44 | Distance Between Grill |
| | and Collection Plate |
| 46 | Grill Elements |
| 48a | Large Nodules |
| 48b | Small Nodules |
| 52 | Thinner Forward Edge |
| | of Nodule |
| 54 | Thicker Rearward Edge |
| | of Nodule |
| 56 | Fluid Routing Channels |
| 58 | Tangs |

### DETAILED DESCRIPTION OF THE DRAWINGS

The present disclosure relates to grilling apparatus that is particularly configured to allow foods to be cooked over an open flame while minimizing flames and smoke. The grilling apparatus is particularly configured to be used indoors. The apparatus employs a grill and an underlying collection plate that cooperate in a manner that contains cooking fluids and suppresses flames. In one particular embodiment, the grill and collection plate are positioned over a charcoal burning stove. The various components of the present invention, and the manner in which they can relate, are described in greater detail hereafter.

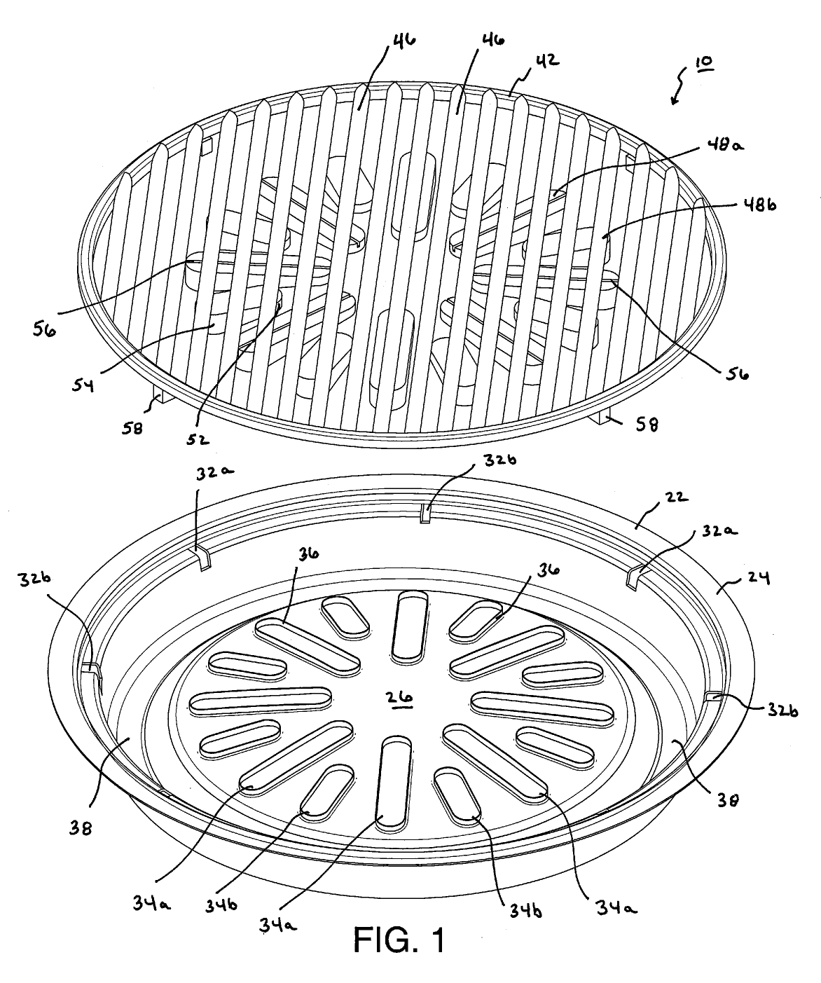

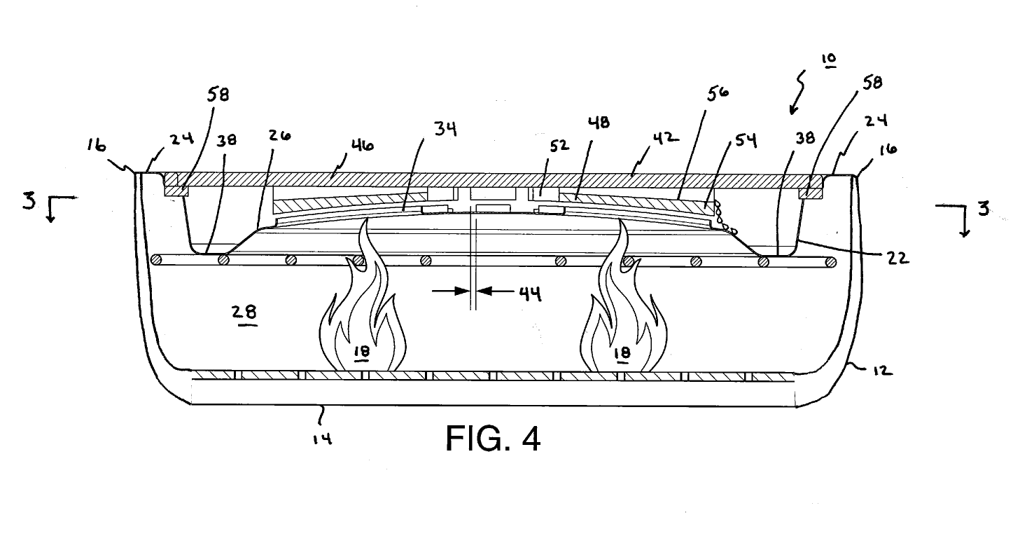

As noted in FIG. 1, the apparatus 10 includes a collection plate 22 and a grill 42. In one particular, but non-limiting example, the collection plate 22 and grill 42 are positioned over top of a stove 12 containing an open flame (FIG. 4). Stove 12 can be of a conventional construction. In the depicted embodiment, stove 12 includes a bottom surface 14 and an upper peripheral edge 16. Bottom surface 14 is ideally used to support a fuel source 18, such as charcoal. It is also possible for apparatus 10 to employ a fuel source other than charcoal, such as propane. Indirect heating can also be used. The upper peripheral edge 16 of stove 12 is use in supporting the grill and collection plate as explained hereinafter.

In accordance with the present disclosure the collection plate 22 is designed to be positioned over the top of stove 12. To facilitate this, collection plate 22 includes a flanged peripheral outer edge 24 that is dimensioned to fit over the peripheral edge 16 of stove 12. However, this is not the only suitable arrangement. Namely, it is also envisioned that the bottom 26 of the collection plate 22 can sit directly upon the top of grill 42. This arrangement avoids the need for the dimensions of edges 16 and 24 to match. It also allows the apparatus 10 to be used with a wider range of conventional grills.

Collection plate 22 preferably includes inwardly angled side walls that terminate at bottom surface 26. In the preferred embodiment, bottom surface 26 has a rounded or arcuate profile. In use, collection plate 22 is positioned over top of stove 12, whereby a space 28 is created between the bottom surface 26 of collection plate 22 and the lower surface 14 of stove 12. First and second notches (32a and 32b) are formed adjacent to the peripheral edge 24 of the collection plate 22. These notches (32a and 32b) have different depths, the function of which is described in greater detail hereinafter. Two sets of slots (34a and 34b) are preferably formed within the bottom surface 26 of collection plate 22. The first set of slots 34a is longer than the second set 34b. Each of the slots has a raised peripheral edge 36 to prevent cooking fluids from entering the slots (34a and 34b). A trough 38 is formed within a peripheral edge of the arcuate bottom surface 26. In use, cooking fluids (i.e. grease, juices, or sauces) that drip down below grill 42 contact bottom surface 26. These fluids are prevented from entering slots (34a or 34b) via edges 36. Additionally, the curvature of surface 26 routes the fluids into trough 38. Fluids collected in trough 38 can be disposed of after the cooking is completed.

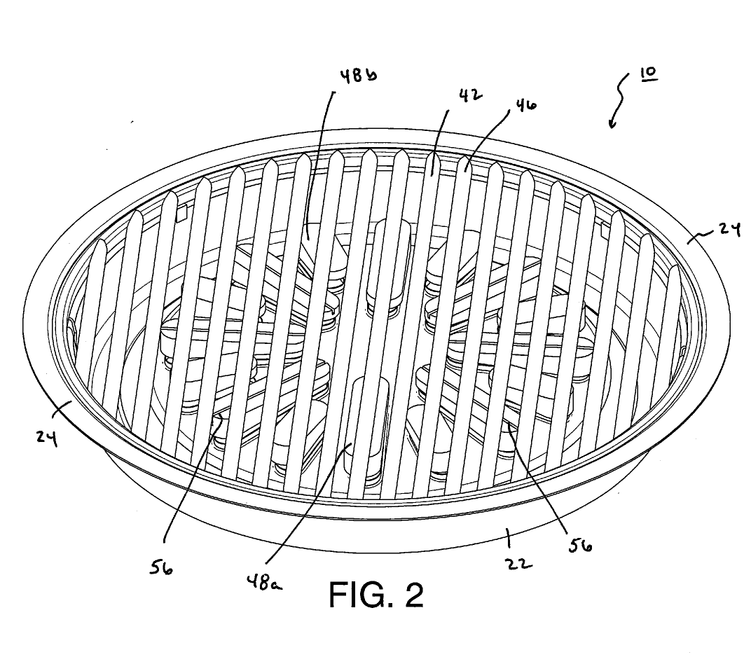

The third component of apparatus 10 is the cooking surface or grill 42. Grill 42 overlies collection plate 22 to create a space 44 between the two components. As noted below, this spacing is adjustable by the user. Grill 42 is preferably formed from a plurality of spaced parallel grill elements 46. However, the use of other arrangements and cooking surfaces can be utilized. Grill 42 also includes a number of nodules (48a and 48b) arrayed in a circular manner on the underside of grill 42. In the depicted embodiment, sixteen individual nodules are arranged in a circular pattern that alternates between large and small nodules (48a and 48b). Nodules (48a and 48b) have the same position and dimensions as slots (34a and 34b). Nodules (42a and 42b) are ideally flame suppressing nodules that are adapted to be positioned over top of slots (34a and 34b). In the preferred embodiment, each of the nodules (48a and 48b) has a thinner forward edge 52 and a thicker rearward edge 54. Furthermore a subset of the larger nodules 48a includes a thin fluid channel 56 within an upper surface. In the depicted embodiment, as illustrated in FIG. 2, six of the larger nodules incorporate a fluid channel 56. If desired, all of the nodules (48a and 48b) may include a fluid channel 56. The purpose of the fluid channel 56 is to route grease dripping onto the underside of grill elements 46 to the outer trough 38.

A series of tangs 58 are formed about the peripheral edge of grill 42. Tangs 58 are adapted to be received within either the first or second notches (32a and 32b) of collection plate 22. With tangs 58 positioned within the first, deeper set of notches 32a the distance between grill 42 and collection plate 22 is greatest. This also results is nodules (48a and 48b) being spaced at a greater distance 44 from the corresponding slots (34a and 34b). Alternatively, with tangs 58 positioned within the second, shallower set of notches 32b, a lesser distance is created between grill 42 and collection plate 22. This likewise results is a lesser distance 44 between nodules (48a and 48b) and corresponding slots (34a and 34b). In one embodiment, the lesser distance between nodules (48a and 48b) and slots (34a and 34b) is approximately ¼ to ⅓ of an inch. Likewise, the greater distance between nodules (48a and 48b) and slots (34a and 34b) is approximately ½ to ¾ of an inch. This adjustability allows the degree of flame suppression and smoke reduction to by varied. Namely, a greater degree of flame suppression and smoke reduction is achieved with the lesser spacing.

Grill 42 and collection plate 22 can be formed from any of a variety of metal casting processes, with sand casting being the preferred technique. In the depicted embodiment, grill 42 and plate 22 components are circular. However, rectangular shaped components can also be used if preferred. Non-stick coatings can be applied to the upper surface of grill 42. Grill 42 and plate 22 are preferably formed from a metal that is dish washer safe, such as cast iron, stainless steel, or porcelain-coated cast iron.

In use, user first puts the fuel source 18 within the bottom 14 of stove 12. Fuel source 18 is then ignited. Collection plate 22 is thereafter positioned over top of stove 12. In the depicted embodiment, this is accomplished by resting the peripheral flange 24 of collection plate 22 upon peripheral edge 16 of stove 12. Otherwise, the bottom 26 of collection plate 22 may simply rest on stove 12. In either arrangement, cooking surface or grill 42 is next positioned over collection plate 22. A pair of tongs (not shown) can be used to lift and position grill 42. Grill 42 is positioned with tangs 58 positioned within either the first or section notches (32a or 32b) of collection plate 22. Food is thereafter cooked on surface 42. As the cooking progresses, fluids from the food (i.e. grease, juices, sauces etc) will drip below grill 42 and onto the collection plate 22. Some of the fluids will be routed via channels 56. Some of the fluids will be rounded via the curved lower surface 26. In either event, the fluids are prevented from entering slots (34a and 34b) via raised edges 36 and are ultimately directed into peripheral trough 38 for later disposal. This arrangement greatly limits, if not eliminates, the smoke created by cooking fluids coming into contact with the open flames. The flame suppression nodules (48a and 48b) also prevent flames from contacting the food and otherwise eliminates, or greatly reduces, flare ups.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An indoor cooking apparatus (10) that permits food to be cooked over an open flame while minimizing smoke and flames, the cooking apparatus comprising:
a stove (12) for containing the open flame, the stove (12) including a bottom surface (14) and an upper peripheral edge (16), a fuel source (18) positioned within the stove (12);
a collection plate (22) having an flanged peripheral edge (24) and an arcuate bottom surface (26), the flanged peripheral edge (24) secured to the upper peripheral edge (16) of the stove (12) such that a space (28) is created between the bottom surface (14) of the stove (12) and the arcuate bottom surface (26) of the collection plate (22), first and second notches (32a and 32b) formed adjacent to the flanged peripheral edge (24) of the collection plate (22), the first and second notches (32a and 32b) having differing depths, sets of large and small slots (34a and 34b) formed within the arcuate bottom surface (26), each of the slots (34a and 34b) including a raised peripheral edge (36), a trough formed (38) within a peripheral edge of the arcuate bottom surface (26);
a grill (42) positioned as a distance (44) above the collection plate (22), the grill (42) formed from a plurality of spaced grill elements (46), a series of large and small flame suppressing nodules (48a and 48b) secured to an underside of the grill (42), the large and small nodules (48a and 48b) corresponding to the large and small slots (34a and 34b) of the collection plate (22), each of the nodules (48a and 48b) having a thinner forward edge (52) and a thicker rearward edge (54), fluid routing channels (56) formed within an upper surface of some of the flame suppression nodules, a series of tangs (58) formed about a peripheral edge of the grill (42), the tangs (58) adapted to be received within either the first or second notches (32a or 32b) of the collection plate (22), the distance between each nodule (48a and 48b) and its corresponding slot (34a and 34b) being varied depending upon whether the tangs (58) are received within the first or second notches (32a or 32b).

2. A cooking apparatus (10) comprising:
a cooking flame;
a collection plate (22) with a peripheral edge (24) and a bottom surface (26), the bottom surface (26) positioned over the cooking flame, a series of slots (34) formed within a bottom surface (26);
a grill (42) secured into the peripheral edge (24) of the collection plat (22), the grill (42) formed from a plurality of spaced grill elements (46), a series of nodules (48) secured to an underside of the grill (42), the nodules (48) corresponding to the slots (34) within the collection plate (22), the nodules (48) partially covering the slots (34) to thereby suppress the smoke and flames generated from cooking fluids.

3. The apparatus as described in claim 2 wherein the flame is created within a stove (12) with an upper peripheral edge (16), and wherein the peripheral edge (24) of collection plate (22) is mounted to the peripheral edge (16) of the stove (12).

4. The apparatus as described in claim 2 further comprising:
first and second notches (32a and 32b) are formed within the peripheral edge (24) of the collection plate (22), with the first and second notches (32a and 32b) having differing depths;
a series of tangs (58) formed about a peripheral edge of the grill (42), the tangs (58) adapted to be received within either the first or second notches (32a or 32b) of the collection plate (22), the distance between each nodule (48) and its corresponding slot (34) being varied depending upon whether the tangs (58) are received within the first or second notches (32a or 32b).

5. The apparatus as described in claim 2 wherein nodules (48) comprise large and small nodules (48a and 48b) and wherein slots (34) comprise large and small slots (34a and 34b), with the size and shape of the large nodules (48a) corresponding to the size and shape of the large slots (34a), and with the size and shape of the small nodules (48b) corresponding to the size and shape of the small slots (34b).

6. The apparatus as described in claim 2 wherein each of the nodules (48) is tapered with a thinner forward edge (52) and a thicker rearward edge (54).

7. The apparatus as described in claim 2 further comprising fluid routing channels (56) formed within an upper surface of some of the nodules (48).

8. The apparatus as described in claim 2 wherein the nodules (48) are arrayed beneath the grill elements (46) in a circle.

9. The apparatus as described in claim 2 further comprising a fluid trough (38) is formed within an outside periphery of the collection plate (22).

10. The apparatus as described in claim 2 further comprising a raised edge (36) formed about each of the slots (34).

11. A cooking apparatus comprising:
a collection plate with one or more female openings formed within a bottom surface, the female openings adapted to be positioned over a heat source;
a cooking surface with one or more male elements positioned upon the cooking surface, the cooking surface being interconnected to the collection plate such that the male elements at least partially obstruct the female openings, whereby smoke from the heat source is suppressed.

12. The apparatus as described in claim 11 wherein the male elements are positioned at a distance above the female openings and wherein the distance is adjustable by the user.
